(19) United States
(12) Patent Application Publication
(10) Pub. No.: US 2024/0404281 A1
(43) Pub. Date: Dec. 5, 2024

(54) ABNORMALITY ANALYSIS APPARATUS, ABNORMALITY ANALYSIS METHOD, AND NON-TRANSITORY COMPUTER-READABLE MEDIUM

(71) Applicant: NEC Corporation, Tokyo (JP)

(72) Inventor: Kenta ISHIHARA, Tokyo (JP)

(73) Assignee: NEC Corporation, Tokyo (JP)

(21) Appl. No.: 18/673,387

(22) Filed: May 24, 2024

(30) Foreign Application Priority Data
May 31, 2023 (JP) 2023-090014

(51) Int. Cl. G06V 20/40

(52) U.S. Cl. CPC G06V 20/41

(57) ABSTRACT

An abnormality analysis apparatus detects, from a first video frame sequence, a second video frame sequence indicating a cycle being a set of a predetermined plurality of actions. The abnormality analysis apparatus determines an action time of each action indicated by the second video frame sequence. The abnormality analysis apparatus analyzes an abnormality of an action indicated by the second video frame sequence, based on order of actions indicated by the second video frame sequence and an action time of each action.

### INCORPORATION BY REFERENCE

This application is based upon and claims the benefit of priority from Japanese patent application No. 2023-090014, filed on May 31, 2023, the disclosure of which is incorporated herein in its entirety by reference.

### TECHNICAL FIELD

The present disclosure relates to an abnormality analysis apparatus, an abnormality analysis method, and a non-transitory computer-readable medium.

### BACKGROUND ART

A technique for detecting an abnormality of an action from a video in which the action is captured has been developed. For example, Japanese Unexamined Patent Application Publication No. 2023-012795 discloses a technique for determining an abnormality of an action by converting an action label group generated from video data into a sentence vector and computing a similarity degree between the generated sentence vector and a predetermined procedural sentence.

### SUMMARY

In Japanese Unexamined Patent Application Publication No. 2023-012795, an abnormality of an action is determined by focusing only on an order of the actions. The present disclosure is made in view of such a problem, and an example objective of the present disclosure is to provide a novel technique for analyzing an abnormality of an action.

In a first example aspect, an abnormality analysis apparatus according to the present disclosure includes at least one memory that is configured to store instructions, and at least one processor. The at least one processor is configured to execute the instructions to: detect, from a first video frame sequence, a second video frame sequence indicating a cycle being a set of a predetermined plurality of actions; determine an action time for each one of the actions indicated by the second video frame sequence; and analyze an abnormality of the actions indicated by the second video frame sequence, based on an order of the actions indicated by the second video frame sequence and the action time of each one of the actions.

In a second example aspect, an abnormality analysis method according to the present disclosure is executed by a computer. The method includes: detecting, from a first video frame sequence, a second video frame sequence indicating a cycle being a set of a predetermined plurality of actions; determining an action time for each one of the actions indicated by the second video frame sequence; and analyzing an abnormality of the actions indicated by the second video frame sequence, based on an order of the actions indicated by the second video frame sequence and the action time of each one of the actions.

In a third example aspect, a non-transitory computer-readable medium stores a program. The program causes a computer to execute: detecting, from a first video frame sequence, a second video frame sequence indicating a cycle being a set of a predetermined plurality of actions; determining an action time for each one of the actions indicated by the second video frame sequence; and analyzing an abnormality of the actions indicated by the second video frame sequence, based on an order of the actions indicated by the second video frame sequence and the action time of each one of the actions.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating an example of a first video frame sequence treated by an abnormality analysis apparatus;

FIG. 2 is a diagram illustrating an example of an overview of an operation of the abnormality analysis apparatus;

FIG. 3 is a block diagram illustrating an example of a functional configuration of the abnormality analysis apparatus;

FIG. 4 is a block diagram illustrating an example of a hardware configuration of a computer that achieves the abnormality analysis apparatus;

FIG. 5 is a flowchart illustrating an example flow of processes executed by the abnormality analysis apparatus;

FIG. 6 is a diagram illustrating an example of class information;

FIG. 7 is a diagram illustrating an example of cycle definition information;

FIG. 8 is a diagram illustrating an example of the first video frame sequence and a target class sequence generated from the first video frame sequence;

FIG. 9 is a flowchart illustrating an example flow of processes for detecting a cycle from the target class sequence;

FIG. 10 is a flowchart illustrating an example flow of processes for detecting a cycle from the target class sequence;

FIG. 11 is a diagram illustrating an example of an action section; and

FIG. 12 is a diagram illustrating an example of a feature vector of the second video frame sequence.

### EXAMPLE EMBODIMENT

Hereinafter, example embodiments of the present disclosure are described in detail with reference to the drawings. In the drawings, the same or corresponding element is denoted by the same reference sign, and redundant descriptions are omitted as necessary for clarity of description. Unless otherwise stated, values set in advance such as a predetermined value and a threshold value are stored in advance in a storage device or the like that can be accessed from an apparatus that utilizes such values. Further, unless otherwise stated, a storage unit is constituted by any number, excluding zero, of storage devices.

### <Overview>

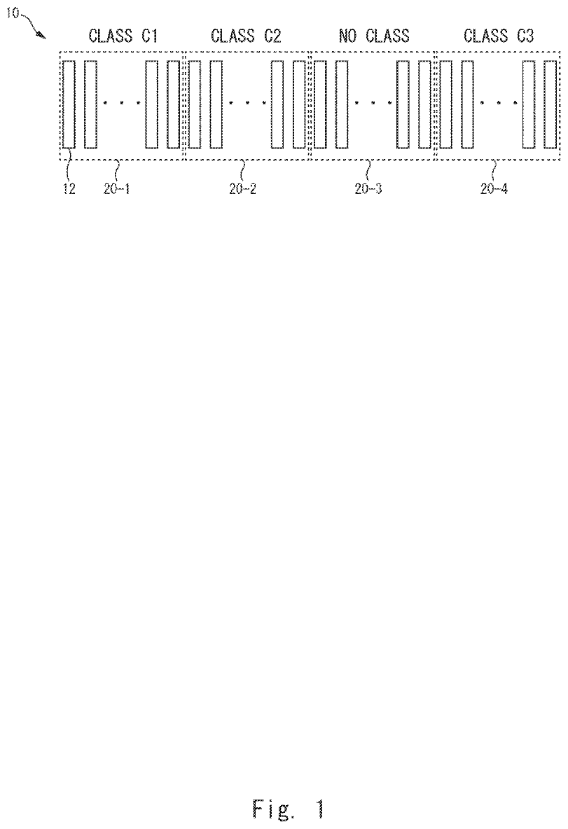

FIG. 1 is a diagram illustrating an example of a first video frame sequence 10 treated by an abnormality analysis apparatus. The first video frame sequence 10 includes a time-series of video frames 12. In other words, the first video frame sequence 10 is a frame sequence in which a plurality of video frames 12 are arranged in chronological order (in ascending order of frame numbers). Each video frame 12 belongs to one of a plurality of classes or does not belong to any of the classes.

The first video frame sequence 10 includes a plurality of chunks 20. The chunk 20 is either 1) a frame sequence constituted by a plurality of consecutive video frames 12 belonging to the same class as each other, or 2) a frame sequence constituted by a plurality of consecutive video frames 12 not belonging to any of the classes.

For example, the first video frame sequence 10 in FIG. 1 includes, in the following order, a chunk 20-1 constituted by a plurality of video frames 12 belonging to a class C1, a chunk 20-2 constituted by a plurality of video frames 12 belonging to a class C2, a chunk 20-3 constituted by a plurality of video frames 12 not belonging to any of the classes, and a chunk 20-4 constituted by a plurality of video frames 12 belonging to a class C3. Hereinafter, a chunk constituted by a plurality of video frames 12 belonging to a class C is also referred to as a “chunk belonging to class C” or a “chunk of class C”.

Herein, the first video frame sequence 10 includes at least three chunks 20 each belonging to different classes. The first video frame sequence 10 may include a plurality of chunks 20 belonging to the same class. For example, there may be a case where four chunks 20 are included in the first video frame sequence 10, and the four chunks 20 belong to classes C1, C2, C3, and C1 in this order.

The first video frame sequence 10 is the whole or a part of video data generated by capturing, by a camera, a situation in which a plurality of actions is performed. Each class is assigned to a different type of action. The action is, for example, an operation performed at a factory, a store, or the like.

For example, it is assumed that a situation in which three actions P1, P2, and P3 are sequentially performed is captured by a video camera, and video data acquired by the capturing is treated as the first video frame sequence 10. It is also assumed that the classes C1, C2, and C3 are assigned to the actions P1, P2, and P3, respectively.

In such a case, the first video frame sequence 10 includes a video frame sequence indicating the action P1, a video frame sequence indicating the action P2, and a video frame sequence indicating the action P3. The video frame sequence indicating the action P1 is a chunk 20 of class C1. The video frame sequence indicating the action P2 is a chunk 20 of class C2. The video frame sequence indicating the action P3 is a chunk 20 of class C3.

Note that, the first video frame sequence 10 may include a video frame sequence that does not indicate any of the actions P1, P2, and P3. Such a video frame sequence is a chunk 20 that does not belong to any of the classes, such as the chunk 20-3 of FIG. 1. Hereinafter, a chunk 20 that do not belong to any of the classes is also referred to as a “non-belonging chunk”.

Hereinafter, unless otherwise stated, in the examples described in the present disclosure, a class Ci is assigned to an action Pi.

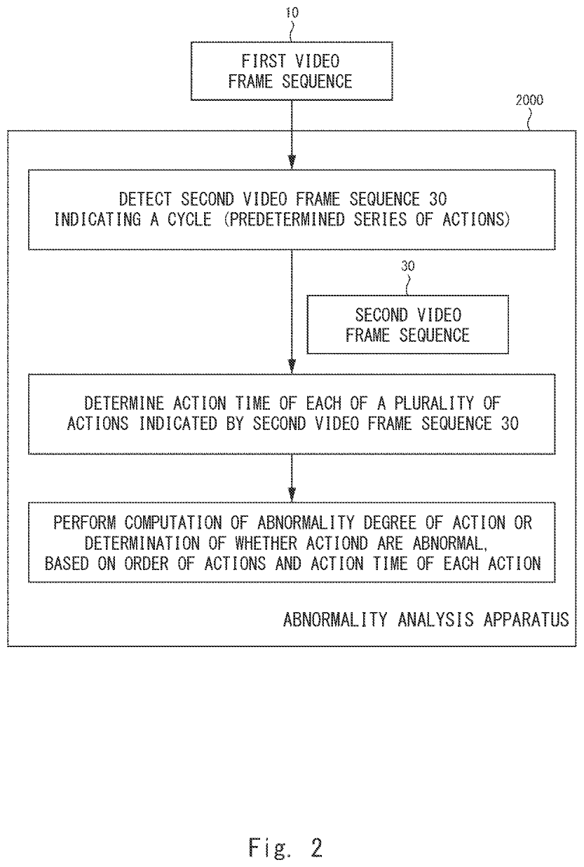

FIG. 2 is a diagram illustrating an example of an overview of an operation of an abnormality analysis apparatus 2000. Herein, FIG. 2 is a diagram for facilitating understanding of the overview of the abnormality analysis apparatus 2000, and the operation of the abnormality analysis apparatus 2000 is not limited to that illustrated in FIG. 2.

The abnormality analysis apparatus 2000 detects, from the first video frame sequence 10, a video frame sequence (hereinafter, a second video frame sequence 30) estimated to indicate a cycle. A cycle means a set of predetermined series of actions.

For example, a series of actions such as “first, perform action P1, then, perform action P2, and finally, perform action P3” is defined as a cycle. In such a case, the cycle may be defined by a permutation of the classes (C1, C2, C3) (hereinafter, a class sequence). Since the class indicates the type of action, the permutation of the classes can may also be referred to as a permutation of actions. Hereinafter, such a class sequence that defines a certain cycle is referred to as a “definition sequence” of the certain cycle.

The abnormality analysis apparatus 2000 determines an action time for each of a plurality of actions indicated by the second video frame sequence 30. Then, the abnormality analysis apparatus 2000 performs abnormality analysis of the actions indicated by the second video frame sequence 30, based on the order of the plurality of actions indicated by the second video frame sequence 30 and the action time of each action. The abnormality analysis of the actions is, for example, computation of a degree of abnormality (hereinafter, abnormality degree) of the actions, determination of whether the actions are abnormal, and the like.

### <Example of Advantageous Effect>

As described above, in Japanese Unexamined Patent Application Publication No. 2023-012795, an abnormality of an action is determined by focusing only on the order of the actions. In this regard, according to the abnormality analysis apparatus 2000 of the present disclosure, the abnormality analysis of actions is performed in consideration of not only the order of the actions but also the action time. Therefore, the abnormality analysis apparatus 2000 according to the present disclosure discloses a novel technique for analyzing an abnormality of an action.

In addition, Japanese Unexamined Patent Application Publication No. 2023-012795 does not refer to detecting a predetermined series of actions from video data. In this regard, according to the abnormality analysis apparatus 2000 of the present disclosure, the second video frame sequence 30 indicating a cycle that is a predetermined series of actions is detected from the first video frame sequence 10. Then, the abnormality analysis of actions is performed with respect to the second video frame sequence 30. Therefore, according to the abnormality analysis apparatus 2000 of the present disclosure, it is possible to analyze an abnormality of actions for each set of actions called a cycle.

By analyzing the abnormality of the action in units of cycles, for example, there is an advantage that the abnormality of the actions can be analyzed with higher accuracy. For example, it is assumed that one cycle is a set of a series of operations. Further, it is assumed that an operator takes a break between cycles.

In such a situation, an action that the operator must take in a predetermined order or in a standard time is an action included in the cycle. Each action during a breaktime is not required to be performed in a predetermined order or in a standard time.

When the abnormality analysis apparatus 2000 is used in this situation, a series of operations performed by the operator is automatically treated as a target of abnormality analysis, while an action during a breaktime is automatically excluded from a target of abnormality analysis. Thus, according to the abnormality analysis apparatus 2000, since a video frame sequence indicating an action that need not to be subjected to the abnormality analysis is automatically excluded from the target of the abnormality analysis, it is possible to perform the abnormality analysis of actions with higher accuracy.

Hereinafter, the abnormality analysis apparatus 2000 of the present example embodiment is described in more detail.

### Functional Configuration Example

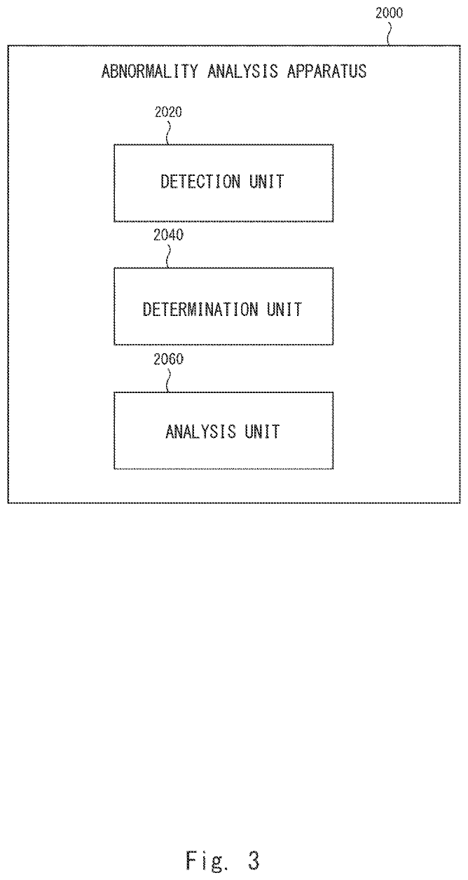

FIG. 3 is a first block diagram illustrating an example of a functional configuration of the abnormality analysis apparatus 2000. The abnormality analysis apparatus 2000 includes a detection unit 2020, an identification unit 2040, and an analysis unit 2060. The detection unit 2020 detects the second video frame sequence 30 from the first video frame sequence 10. The determination unit 2040 determines the action time for each of the plurality of actions indicated by the second video frame sequence 30. The analysis unit 2060 performs abnormality analysis of the action indicated by the second video frame sequence 30, based on the order of the actions and the action time of each action.

### Hardware Configuration Example

Each functional component of the abnormality analysis apparatus 2000 may be achieved by hardware (for example, a hardwired electronic circuit or the like) that achieves each functional component, or may be achieved by a combination of hardware and software (for example, a combination of an electronic circuit and a program that controls the electronic circuit, or the like). Hereinafter, a case where each functional component of the abnormality analysis apparatus 2000 is achieved by a combination of hardware and software is further described.

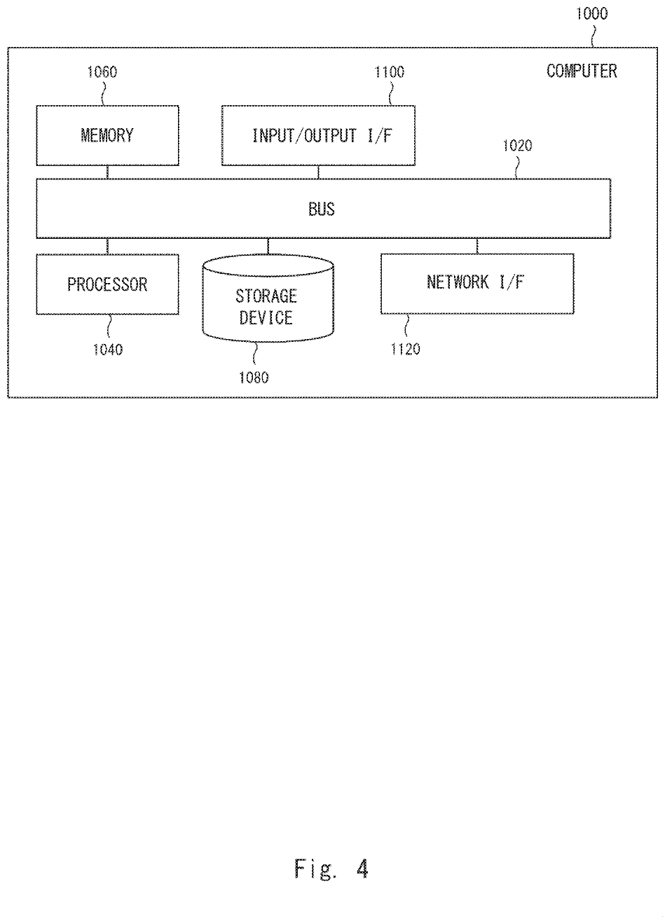

FIG. 4 is a block diagram illustrating an example of a hardware configuration of a computer 1000 that achieves the abnormality analysis apparatus 2000. The computer 1000 may be any computer. For example, the computer 1000 is a stationary computer such as a personal computer (PC) or a server machine. In another example, the computer 1000 is a portable computer such as a smartphone or a tablet terminal. The computer 1000 may be a special-purpose computer designed to achieve the abnormality analysis apparatus 2000, or may be a general-purpose computer.

For example, each function of the abnormality analysis apparatus 2000 may be achieved by the computer 1000 by installing a predetermined application on the computer 1000. Such an application is configured by a program for achieving each functional component of the abnormality analysis apparatus 2000. The method for acquiring the program may be any method. For example, the program may be acquired from a storage medium (such as a DVD disk or a USB memory) storing the program. In another example, the program may be acquired by downloading the program from a server device managing a storage device in which the program is stored.

The computer 1000 includes a bus 1020, a processor 1040, a memory 1060, a storage device 1080, an input/output interface 1100, and a network interface 1120. The bus 1020 is a data transmission path through which the processor 1040, the memory 1060, the storage device 1080, the input/output interface 1100, and the network interface 1120 transmit and receive data to and from one another. However, the method for connecting the processors 1040 and the like to one another is not limited to bus connection.

The processor 1040 may be various processors, such as a central processing unit (CPU), a graphics processing unit (GPU), or a field-programmable gate array (FPGA). The memory 1060 is a main storage device achieved by using a random access memory (RAM) or the like. The storage device 1080 is an auxiliary storage device achieved by using a hard disk, a solid state drive (SSD), a memory card, a read only memory (ROM), or the like.

The input/output interface 1100 is an interface for connecting the computer 1000 and the input/output device. For example, an input device such as a keyboard or an output device such as a display device is connected to the input/output interface 1100.

The network interface 1120 is an interface for connecting the computer 1000 to a network. The network may be a local area network (LAN) or a wide area network (WAN).

The storage device 1080 stores a program (a program for implementing the above-described application) for achieving each functional component of the abnormality analysis apparatus 2000. The processor 1040 reads the program into the memory 1060 and executes the program, and thereby achieves the functional components of the abnormality analysis apparatus 2000.

The abnormality analysis apparatus 2000 may be achieved by one computer 1000 or by a plurality of computers 1000. In the latter case, the configuration of each computer 1000 need not be the same, but may be different.

### <Flow of Processes>

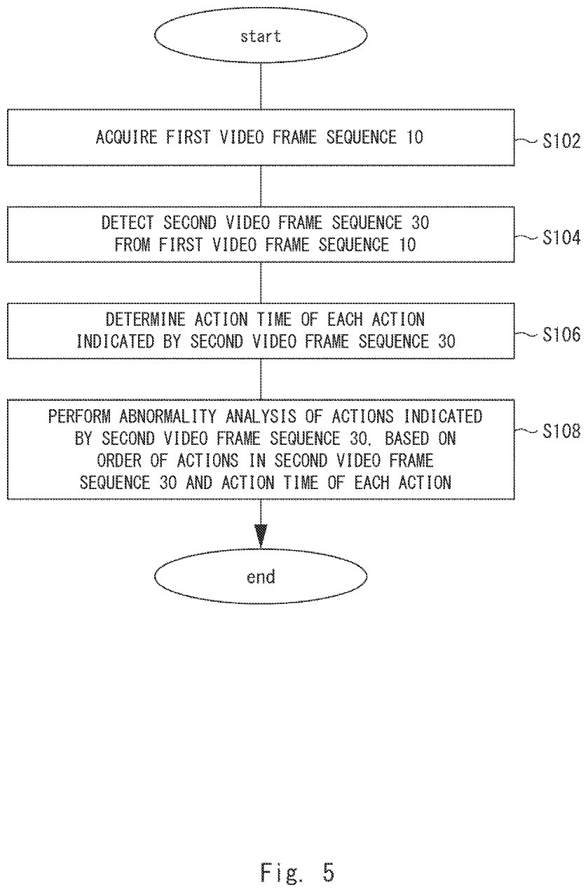

FIG. 5 is a flowchart illustrating an example flow of processes executed by the abnormality analysis apparatus 2000. The detection unit 2020 acquires the first video frame sequence 10 (S102). The detection unit 2020 detects the second video frame sequence 30 from the first video frame sequence 10 (S104). The determination unit 2040 determines the action time for each action indicated by the second video frame sequence 30 (S106). The analysis unit 2060 performs abnormality analysis of the actions indicated by the second video frame sequence 30, based on the order of the plurality of actions indicated by the second video frame sequence 30 and the action time of each action (S108).

### <Acquisition of First Video Frame Sequence 10: S102>

The detection unit 2020 acquires the first video frame sequence 10 (S102). Herein, various methods may be adopted as a method for acquiring a video frame sequence to be processed. For example, the first video frame sequence 10 is stored in any storage unit in advance, in such a manner that the first video frame sequence 10 can be acquired from the abnormality analysis apparatus 2000. In such a case, the detection unit 2020 acquires the first video frame sequence 10 by reading the first video frame sequence 10 out of the storage unit.

In another example, the detection unit 2020 acquires the first video frame sequence 10 by receiving the first video frame sequence 10 transmitted from another apparatus. The apparatus that transmits the first video frame sequence 10 is, for example, an apparatus that generated the first video frame sequence 10. In a case where the first video frame sequence 10 is video data, the detection unit 2020 acquires, for example, the first video frame sequence 10 from a video camera that generated the first video frame sequence 10.

Here, the whole of the first video frame sequence 10 may be acquired at once, or may be acquired incrementally. In the latter case, for example, the detection unit 2020 acquires the first video frame sequence 10 by sequentially acquiring the video frames 12 generated by the video camera.

### <<Determination of Class of Video Frame 12>>

The abnormality analysis apparatus 2000 divides the first video frame sequence 10 into the chunks 20 by determining the classes to which the respective video frames 12 belong. Therefore, the abnormality analysis apparatus 2000 needs to be able to determine the class to which each video frame 12 belongs.

The method for identifying the class to which each video frame 12 belongs may be various methods. For example, the abnormality analysis apparatus 2000 acquires information (hereinafter, class information) indicating a class to which each video frame 12 belongs.

For example, the class information indicates, for each video frame 12 included in the first video frame sequence 10, an association between identification information (for example, a frame number) of the video frame 12 and identification information of a class to which the video frame 12 belongs. In another example, the class information indicates information identifying each chunk 20 included in the first video frame sequence 10 and class information of the chunk 20 in association with each other. The information identifying the chunk 20 is, for example, identification information of one or both of a head video frame 12 and a tail video frame 12 of the chunk 20.

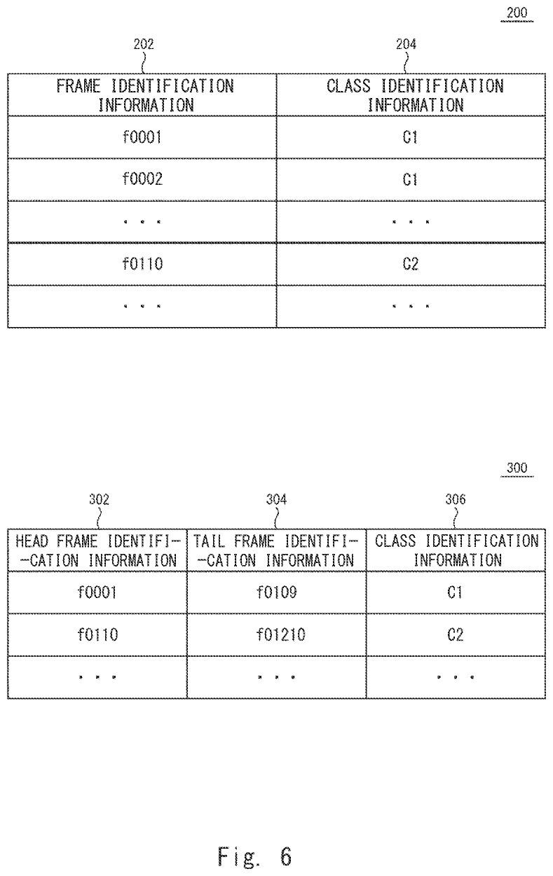

FIG. 6 is a diagram illustrating an example of class information. A table 200 indicates, for each video frame 12, a class to which the video frame 12 belongs. More specifically, identification information (class identification information 204) of the class to which the video frame 12 belongs is indicated in association with identification information (frame identification information 202) of the video frame 12.

The table 300 indicates, for each chunk 20, a class to which the chunk 20 belongs. More specifically, for each chunk 20, identification information (class identification information 306) of the class to which the chunk 20 belongs is indicated in association with a combination of identification information (head frame identification information 302) of the head video frame 12 and identification information (tail frame identification information 304) of the tail video frame 12.

The class information may be information integrated with the first video frame sequence 10 or information separate from the first video frame sequence 10. In the former case, for example, identification information of a class to which the video frame 12 belongs is added as metadata to each video frame 12 included in the first video frame sequence 10. When the first video frame sequence 10 and the class information are configured separately, for example, the detection unit 2020 further acquires the class information about the first video frame sequence 10 in addition to the first video frame sequence 10.

A method for acquiring the class information is similar to the method for acquiring the first video frame sequence 10. For example, the class information is stored in advance in the storage unit in such a manner that the class information can be acquired from the abnormality analysis apparatus 2000. The detection unit 2020 acquires the class information by reading the class information out of the storage unit. In another example, the abnormality analysis apparatus 2000 may acquire the class information by acquiring the class information transmitted by another apparatus (for example, an apparatus that generated the class information).

The abnormality analysis apparatus 2000 may determine the class to which each video frame 12 belongs by analyzing the first video frame sequence 10 without using the class information. The determination of the class to which each video frame belongs may be achieved by using, for example, a machine learning-based model such as a neural network. Hereinafter, such a model is referred to as a “classification model”.

The classification model is configured to assign one of a plurality of predetermined classes to each video frame constituting a video frame sequence in response to receiving the video frame sequence as input. Herein, assigning the class C to a video frame F means that the video frame F belongs to the class C. The abnormality analysis apparatus 2000 determines the class of each video frame 12 constituting the first video frame sequence 10 by inputting the first video frame sequence 10 to the classification model.

### <Detection of Second Video Frame Sequence 30: S104>

The detection unit 2020 detects the second video frame sequence 30 from the first video frame sequence 10 (S104). As described above, the second video frame sequence 30 indicates a cycle (a set of predetermined series of actions).

For example, the detection unit 2020 detects the head and the tail of a cycle from the first video frame sequence 10. Then, the detection unit 2020 detects a video frame sequence including all the chunks 20 from the head to the tail of the cycle from the first video frame sequence 10 as the second video frame sequence 30 indicating the cycle.

The head and the tail of a cycle are each defined by, for example, a class sequence. For example, it is assumed that a definition sequence for a cycle S1 is (C1, C3, C4, C7, C5, C2, C11, C8, C9). Also, it is assumed that the head and the tail of a cycle are defined by a class sequence constituted by the first three items and a class sequence constituted by the last four items, respectively.

In such a case, the head of the cycle S1 is defined by a class sequence of (C1, C3, C4). The tail of the cycle S1 is defined by a class sequence of (C2, C11, C8, C9).

Hereinafter, a class sequence indicating the head of a cycle is also referred to as a “head class sequence”. A class sequence indicating the tail of a cycle is also referred to as a “tail class sequence”.

The numbers of classes included in the head class sequence and the tail class sequence may be the same as or different from each other. Hereinafter, the length of the head class sequence and the length of the tail class sequence are denoted as Ns and Ne.

One or both of Ns and Ne may be 1. That is, one or both of the head class sequence and the tail class sequence may be constituted by a single class.

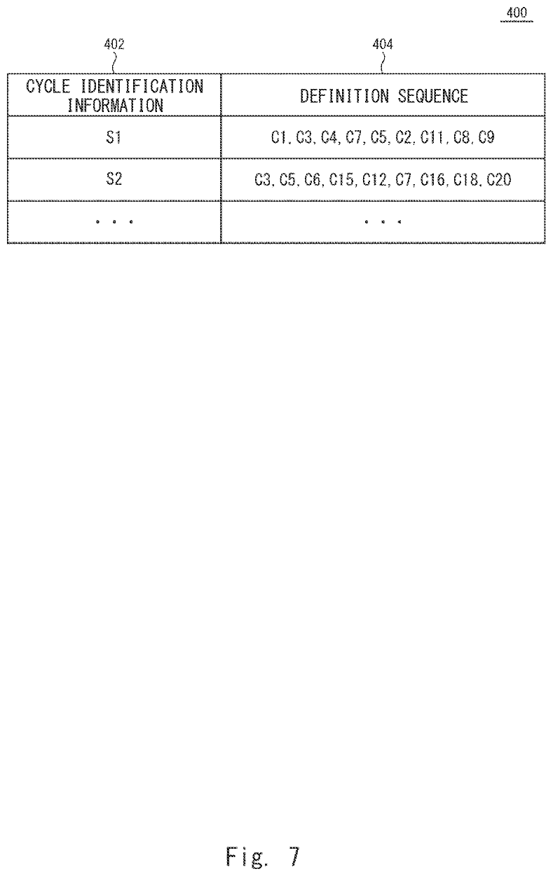

The detection unit 2020 uses cycle definition information, which is information indicating a definition of a cycle. FIG. 7 is a diagram illustrating an example of cycle definition information. The cycle definition information 400 of FIG. 7 includes two columns, named cycle identification information 402 and definition sequence 404. The cycle identification information 402 indicates identification information of a cycle (for example, a number, a symbol, or the like assigned to each cycle). The definition sequence 404 is a definition sequence of a cycle, that is, a class sequence indicating a series of actions constituting the cycle. For example, the first row of the cycle definition information 400 in FIG. 7 indicates that the definition sequence of the cycle S1 is (C1, C3, C4, C7, C5, C2, C11, C8, C9).

The cycle definition information 400 may indicate the lengths of the head class sequence and the tail class sequence for each cycle. In this way, it is possible to define the lengths of the head class sequence and the tail class sequence for each cycle.

The cycle definition information 400 may associate one cycle with a plurality of definition sequences. In this way, it is possible to determine a plurality of orders of normal actions for a cycle. Therefore, it is possible to provide flexibility in the order of the actions.

In order to detect the head and the tail of a cycle from the first video frame sequence 10, the detection unit 2020 replaces the first video frame sequence 10 with a class sequence (hereinafter referred to as a target class sequence). The target class sequence is a sequence in which the classes of the chunks 20 included in the first video frame sequence 10 are placed in time series.

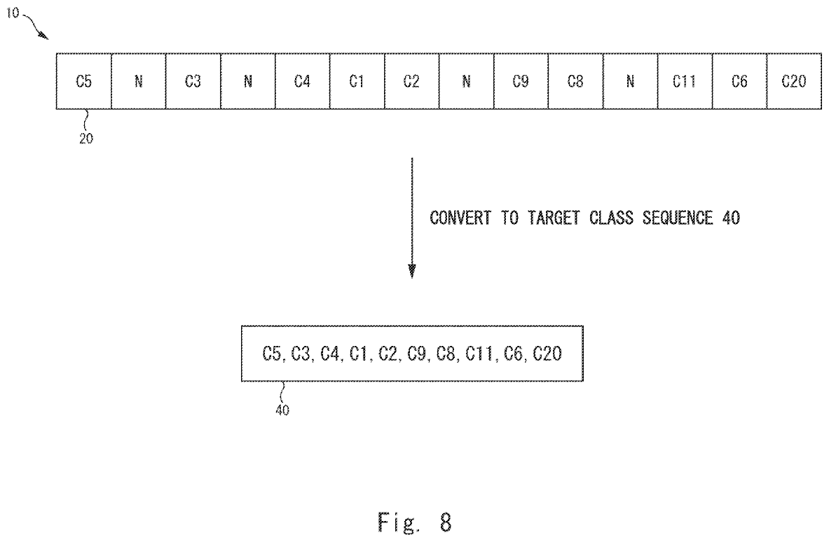

FIG. 8 is a diagram illustrating an example of a first video frame sequence 10 and a target class sequence 40 generated from the first video frame sequence 10. In FIG. 8, N indicates a non-belonging chunk.

The detection unit 2020 does not need to include a non-belonging chunk in the target class sequence 40. For example, the target class sequence 40 in FIG. 8 does not include a non-belonging chunk.

Here, in a case where the target class sequence 40 does not include a non-belonging chunk, there is a possibility that the same classes are consecutive in the target class sequence 40. For example, when a non-belonging chunk is excluded from the class sequence (C2, C1, N, C1, C5), it becomes (C2, C1, C1, C5) where C1 is consecutive. The detection unit 2020 may combine consecutive identical classes into one in the target class sequence 40. For example, (C2, C1, C1, C5) is converted into (C2, C1, C5).

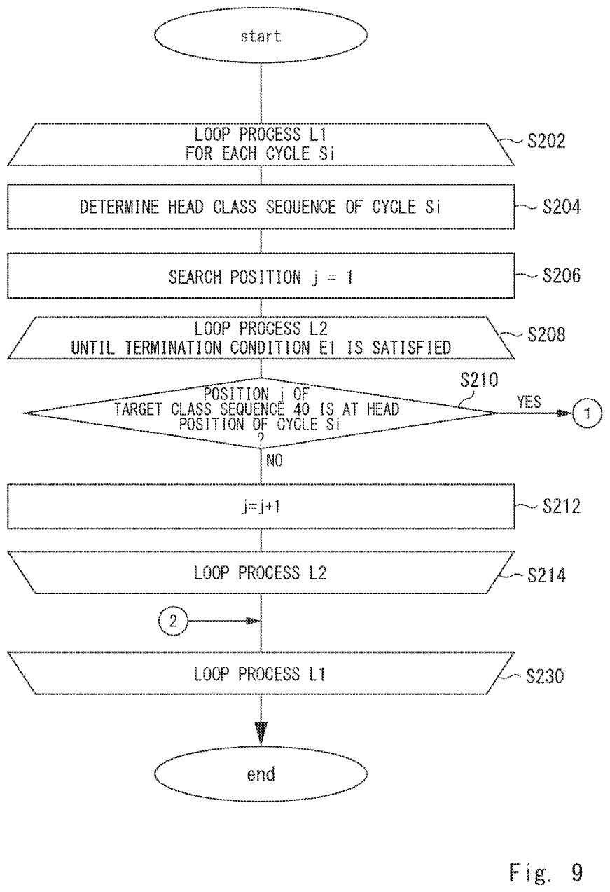

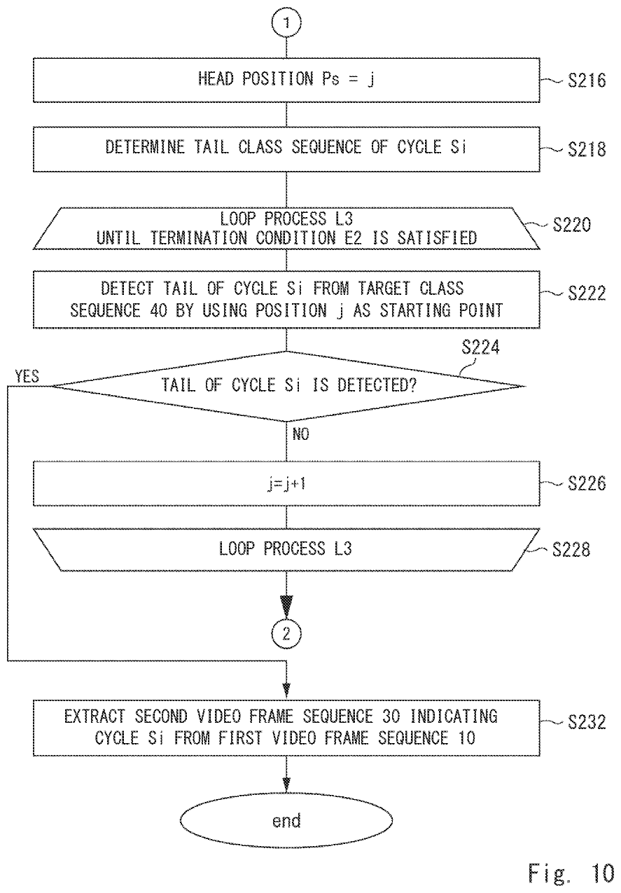

For example, the detection unit 2020 attempts to detect the head and the tail of a cycle from the target class sequence 40, for each of one or more cycles. Thus, for each cycle, the detection unit 2020 attempts to detect a second video frame sequence 30 indicating the cycle from the first video frame sequence 10. FIGS. 9 and 10 are flowcharts illustrating an example flow of processes for detecting a cycle from the target class sequence 40.

Steps S202 to S230 constitute a loop process L1. The loop process L1 is performed for every cycle attempted to be detected from the first video frame sequence 10.

In step S202, the detection unit 2020 determines whether the loop process L1 has already been executed for all cycles to be detected. When the loop process L1 has already been executed for all the cycles to be detected, the detection unit 2020 terminates the detection of the cycle.

When there are cycles that are not yet the target of the loop process L1 in the cycles to be detected, the detection unit 2020 selects one of the cycles that are not treated as a target of the loop process L1 yet. The cycle selected herein is denoted as “cycle Si”. Thereafter, step S204 is executed.

The detection unit 2020 determines a head class sequence of the cycle Si by using the cycle definition information 400 (S204). For example, it is assumed that a class sequence constituted by the first three classes of a cycle is treated as the head class sequence of the cycle. In such a case, the detection unit 2020 determines the head class sequence of the cycle Si by extracting, from the definition sequence 404 of the cycle Si indicated by the cycle definition information 400, a class sequence that is at the head and whose length is 3.

In step S206, the detection unit 2020 initializes a search position j to 1 (the head of the target class sequence 40).

Steps S208 to S214 constitute a loop process L2. The loop process L2 is a process performed in order to detect the head of the cycle Si from the target class sequence 40.

The loop process L2 is repeatedly executed until a predetermined termination condition E1 is satisfied. The termination condition E1 is, for example, “the position j reaches the tail of the target class sequence 40”, “the length of a portion not searched in the target class sequence 40 is shorter than the length of the cycle Si”, or the like.

In step S208, the detection unit 2020 determines whether the termination condition E1 is satisfied. If the termination condition E1 is satisfied, the processing of the flowchart proceeds to step S230. Since step S230 is the endpoint of the loop process L1, the processing of the flowchart proceeds to step S202.

If the termination condition E1 is not satisfied in step S208, the detection unit 2020 executes step S210. In step S210, the detection unit 2020 determines, based on the head class sequence of the cycle Si, whether the position j of the target class sequence 40 is at the head position of the cycle Si.

If the position j of the target class sequence 40 is not at the head position of the cycle Si (S210: NO), 1 is added to the position j (S212), and then the current iteration of the loop process L2 is completed (S214). Then, the processing of the flowchart proceeds to step S208, which is the head of the loop process L2.

In step S210, if the position j of the target class sequence 40 is at the head of the cycle Si (S210: YES), the detection unit 2020 records the current value of j as the head position Ps of the cycle Si (S216). In step S210, if the position j of the target class sequence 40 is at the head position of the cycle Si, the loop process L2 is completed.

Thereafter, the detection unit 2020 attempts to detect the tail of the cycle Si from a portion of the target class sequence 40 that is after the current position j. First, the detection unit 2020 determines the tail class sequence of the cycle Si by using the cycle definition information 400 (S218).

Steps S220 to S228 constitute a loop process L3. The loop process L3 is a process performed in order to detect the tail of the cycle Si from a portion of the target class sequence 40 on and after the position j. The loop process L3 is repeatedly executed until a predetermined termination condition E2 is satisfied. The termination condition E2 is similar to the termination condition of the loop processing L2.

In step S220, the detection unit 2020 determines whether the termination condition E2 is satisfied. If the termination condition E2 is satisfied, the processing of the flowchart proceeds to step S230. Since step S230 is the endpoint of the loop processing L1, the processing of the flowchart proceeds to step S202.

Meanwhile, if the termination condition E2 is not satisfied in step S220, step S222 is executed. In step S222, the detection unit 2020 detects the tail of the cycle Si from the target class sequence 40 by using the position j as a base point.

When the tail of the cycle Si is not detected in S222 (S224: NO), 1 is added to the position j (S226), and then the current iteration of the loop process L3 is completed (S228). Then, the processing of the flowchart proceeds to step S220, which is the head of the loop process L3.

When the tail of the cycle Si is detected in step S222 (S224: YES), the detection unit 2020 extracts the second video frame sequence 30 indicating the cycle Si from the first video frame sequence 10 (S232).

Here, in a case where a plurality of cycles may be included in the first video frame sequence 10, after the execution of S232, the detection unit 202 starts the processing again from S202. However, at this time, the initial value set as the search position j in S206 is set to a position immediately after a second video frame sequence 30 detected in the latest S232. In this way, after the second video frame sequence 30 is detected from the first video frame sequence 10, a cycle is further detected for the remaining portion of the first video frame sequence 10.

Here, as described above, the cycle definition information 400 may indicate a plurality of definition sequences for a single cycle. When there is a plurality of definition sequences of the cycle Si, the determination unit 2040 generates the head class sequence and the tail class sequence of the cycle Si from each of the plurality of definition sequences. Then, the determination unit 2040 attempts to detect the head of the cycle Si from the target class sequence 40 by using each of the plurality of head class sequences. Similarly, the identification unit 2040 attempts to detect the tail of the cycle Si from the target class sequence 40 by using each of the plurality of tail class sequences.

### <<Cycle to be Detected: S202>>

The cycle to be detected may be all cycles included in the cycle definition information 400 or some of the cycles included in the cycle definition information 400. In the latter case, by limiting the cycle to be detected, the processing of detecting the second video frame sequence 30 from the first video frame sequence 10 can be performed efficiently and in shorter time, compared with the case where all the cycles are to be detected.

The detection unit 2020 determines one or more cycles that may be indicated by the first video frame sequence 10 in various ways. There are various ways to determine the cycles that may be indicated by the first video frame sequence 10. For example, the detection unit 2020 determines a cycle that may be indicated by the first video frame sequence 10 by receiving a user input designating a cycle that may be indicated by the first video frame sequence 10.

In another example, the detection unit 2020 determines a cycle that may be indicated by the first video frame sequence 10, based on a location captured in the first video frame sequence 10. According to such a method, a cycle that may be indicated by the first video frame sequence 10 is able to be determined in situations where actions being performed may differ depending on the location.

In such a case, information associating a location with one or more cycles that may be performed at such location is stored in advance in the storage unit, in such a manner that the information can be acquired from the abnormality analysis apparatus 2000. The detection unit 2020 determines a location being captured in the first video frame sequence 10, and determines one or more cycles associated with the determined location as cycles that can be indicated by first video frame sequence 10.

There are various ways to determine a location captured in the first video frame sequence 10. For example, the location captured in the first video frame sequence 10 may be determined by an input by a user of the abnormality analysis apparatus 2000. In another example, the location captured in the first video frame sequence 10 may be determined, based on an installation location or an imaging range of the camera that generated the first video frame sequence 10.

The detection unit 2020 may determine a cycle that may be indicated by the first video frame sequence 10, based on a person captured in the first video frame sequence 10. According to such a method, for example, a cycle that may be indicated by the first video frame sequence 10 is able to be identified in situations where actions being performed may differ depending on the person performing the action.

In such a case, information associating a person with one or more cycles that may be performed by the person is stored in advance in the storage unit in such a manner that the information can be acquired from the abnormality analysis apparatus 2000. The detection unit 2020 determines a person being captured in the first video frame sequence 10 and determines one or more cycles associated with the determined person as cycles that can be indicated by the first video frame sequence 10.

### <<Detection of Head of Cycle: S210>>

The detection unit 2020 determines, based on the head class sequence of the cycle Si, whether the position j of the target class sequence 40 is at the head position of the cycle Si (S210). Several specific examples of a determination method therefor are described below.

For example, the detection unit 2020 determines whether a class at the position j of the target class sequence 40 is a class included in the head class sequence. When the class at the position j of the target class sequence 40 is a class included in the head class sequence, the detection unit 2020 determines that the position j is the head position of the cycle Si. Meanwhile, when the class at the position j of the target class sequence 40 is not a class included in the head class sequence, the detection unit 2020 determines that the position j is not the head position of the cycle Si.

In another example, the detection unit 2020 determines, for the target class sequence 40, whether the class sequence starting from the position j and having the length Ns matches the head class sequence of the cycle Si. When the class sequence starting from the position j and having the length Ns matches the head class sequence of the cycle Si, the detection unit 2020 determines that the position j is the head position of the cycle Si. Meanwhile, when the class sequence starting from the position j and having the length Ns does not match the head class sequence of the cycle Si, the detection unit 2020 determines that the position j is not the head position of the cycle Si.

In another example, when both of the following conditions 1 and 2 are satisfied, the detection unit 2020 determines that the position j is the head of the cycle Si.

(Condition 1) In the target class sequence 40, all the classes included in a class sequence starting from the position j and having a length x (1<x<Ns) are classes included in the head class sequence of the cycle Si.

(Condition 2) An order relationship of the classes in the class sequence having the length x matches an order relationship of the classes in the head class sequence of the cycle Si.

For example, it is assumed that the head class sequence of the cycle Si is (C1, C3, C4), and x=2. The order relationship of classes in this head class sequence includes: “C1 is before C3 and C4”, “C3 is after C1 and before C4”, and “C4 is after C1 and C3”. Class sequences having a length of 2 and that satisfy such a relationship are (C1, C3), (C1, C4), and (C3, C4).

Accordingly, in the target class sequence 40, when the class sequence starting from the position j and having a length of 2 is (C1, C3), (C1, C4), or (C3, C4), the detection unit 2020 determines that the position j is the head position of the cycle Si. Meanwhile, in the target class sequence 40, when the class sequence starting from the position i and having a length of 2 is none of the above-described three class sequences, the detection unit 2020 determines that the position j is not the head position of the cycle Si.

Here, in the determination of condition 2, it is possible not to accept a lack of an action. When the head class sequence of cycle Si is (C1, C3, C4), class sequences satisfying condition 2 are two class sequences (C1, C3) and (C3, C4). A class sequence (C1, C4) lacks C3 between C1 and C4, and therefore is determined not to satisfy condition 2.

In another example, the detection unit 2020 may determine that the position j is the head position of the cycle Si even when only the above-described condition 1 is satisfied. That is, the detection unit 2020 determines whether the above-described condition 1 is satisfied, and when the condition 1 is satisfied, determines that the position j is the head position of the cycle Si. Meanwhile, when the condition 1 is not satisfied, the detection unit 2020 determines that the position j is not the head position of the cycle Si.

For example, it is assumed that the head class sequence of the cycle Si is (C1, C3, C4), and x=2. The detection unit 2020 determines that the position j is the head position of the cycle Si when the class sequence starting from the position j and having a length of 2 is (C1, C3), (C1, C4), (C3, C1), (C3, C4), (C4, C1), or (C4, C3).

According to the above-described various methods of determining the position of the head of the cycle Si with respect to the target class sequence 40, the position of the head of the cycle Si can be accurately detected with respect to the target class sequence 40. Therefore, the abnormality analysis apparatus 2000 can accurately detect the cycle Si from the first video frame sequence 10.

### <<Detection of Tail of Cycle: S222>>

The detection unit 2020 detects the tail of the cycle Si from the target class sequence 40 with the position j as a base point (S222). Several specific examples of this detection method are described below.

For example, the detection unit 2020 determines whether the class at the position j of the target class sequence 40 is a class included in the tail class sequence. When the class of the position j of the target class sequence 40 is a class included in the tail class sequence, the detection unit 2020 determines the position of the tail of the cycle Si with respect to the target class sequence 40. Specifically, the detection unit 2020 detects a class that is not included in the tail class sequence of the cycle Si from a portion of the target class sequence 40 that is after the position j. Then, the detection unit 2020 determines a position preceding the detected class as the tail of the cycle Si.

For example, it is assumed that the tail class sequence of the cycle Si is (C2, C11, C8, C9). Further, in the target class sequence 40, it is assumed that the class sequence on and after the position j is (C8, C11, C3, C1, . . . ).

A class C8 at the position j is included in the tail class sequence of cycle Si. Therefore, the detection unit 2020 detects a class that is not included in the tail class sequence of the cycle Si from a portion after the position j. In this case, the class C3 is detected. Therefore, the position of the class C11, which is the position preceding class C3, is determined as the position of the cycle Si.

When the position of the tail of the cycle Si is determined, it is determined in step S224 that the tail of the cycle Si is detected (S224: YES). The same applies to the description hereinafter.

When the class at the position j of the target class sequence 40 is not a class included in the tail class sequence, the detection unit 2020 determines that the tail of the cycle Si is not detected in step S224 (S224: NO).

In another example, the detection unit 2020 determines whether the class sequence starting from the position j and having the length Ne matches the tail class sequence of the cycle Si in the target class sequence 40. When the class sequence starting from the position j and having the length Ne matches the tail class sequence of the cycle Si, the detection unit 2020 determines the position of the tail of the cycle Si with respect to the target class sequence 40. Specifically, the detection unit 2020 detects a class not included in the tail class sequence of the cycle Si from a portion of the target class sequence 40 on and after the position j+Ne (including the position j+Ne). Then, the detection unit 2020 determines a position preceding the detected class as the position of the tail of the cycle Si.

When the class sequence starting from the position j and having the length Ne does not match the tail class sequence of the cycle Si, the detection unit 2020 determines that the tail of the cycle Si is not detected in step S222 (S224: NO).

In another example, the detection unit 2020 determines whether both of the following conditions 3 and 4 are satisfied.

(Condition 3) In the target class sequence 40, all the classes included in a class sequence starting from the position j and having a length b (1<b<Ne) are classes included in the tail class sequence of the cycle Si.

(Condition 4) The order relationship of the classes in the class sequence having the length b matches the order relationship of the classes in the tail class sequence of the cycle Si.

When the conditions 3 and 4 are satisfied, the detection unit 2020 determines the position of the tail of the cycle Si with respect to the target class sequence 40. Specifically, the detection unit 2020 detects a class that is not included in the tail class sequence of the cycle Si from a portion on and after the position j+b (including the position j+b) in the target class sequence 40. Then, the detection unit 2020 determines a position preceding the detected class as the position of the tail of the cycle Si.

When at least either of the conditions 3 and 4 is not satisfied, the detection unit 2020 determines that the tail of the cycle Si is not detected in step S224 (S224: NO).

In another example, the detection unit 2020 may determine that the tail of the cycle Si is not detected in step S224, only when the above-described condition 3 is not satisfied. In such a case, when the condition 3 is satisfied, then the detection unit 2020 detects a class that is not included in the tail class sequence of the cycle Si from a portion on and after the position j+b (including the position j+b) in the target class sequence 40. Then, the detection unit 2020 determines a position preceding the detected class as the position of the tail of the cycle Si.

According to the above-described various methods for determining the position of the tail of the cycle Si with respect to the target class sequence 40, it is possible to accurately detect the position of the tail of the cycle Si with respect to the target class sequence 40. Therefore, the abnormality analysis apparatus 2000 can accurately detect the cycle Si from the first video frame sequence 10.

### <Determination of Action Time: S106>

The determination unit 2040 determines the action time for each action from the second video frame sequence 30 (S106). For example, for each action, the determination unit 2040 determines an action section, which is a section indicating the action, from the second video frame sequence 30.

An action section of an action is indicated by a chunk 20 of a class of the action. However, when there is a non-belonging chunk among the plurality of chunks 20 belonging to the same class, the same action section is indicated by the plurality of chunks 20.

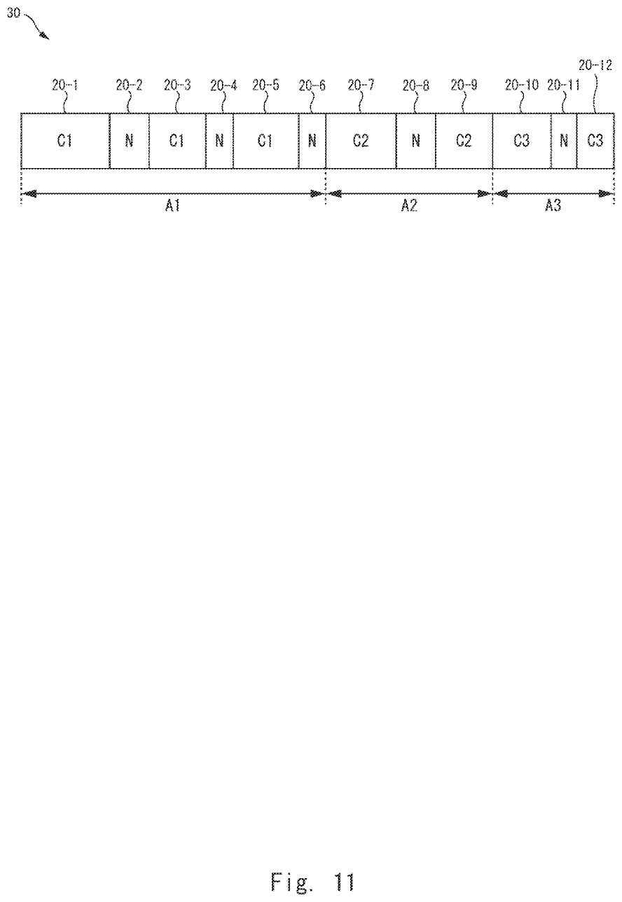

FIG. 11 is a diagram illustrating an example of an action section. In FIG. 11, the second video frame sequence 30 includes an action section A1 of the action P1, an action section A2 of the action P2, and an action section A3 of the action P3. The action section A1 starts from the chunk 20 of the class C1 and ends immediately before the chunk 20 of the class C2. The action section A2 starts from the chunk 20 of the class C2 and ends immediately before the chunk 20 of the class C3. The action section A3 starts from the chunk 20 of the class C3 and ends at the tail of the second video frame sequence 30.

For example, the action section includes an actual action section, an interruption section, and a transition section. An actual action section in an action section of a certain action P is a section in which the action P is performed. More specifically, the actual action section is indicated by a chunk 20 that is not a non-belonging chunk. For example, in FIG. 11, the actual action section of the action section A1 is a chunk 20-1, a chunk 20-3, and a chunk 20-5.

The interruption section in the action section of the action P is a section in which the execution of the action P is interrupted. Specifically, the interruption section is indicated by a non-belonging chunk in a position other than the tail of the action section. For example, in FIG. 11, the interrupted section of the action section A1 is a chunk 20-2 and a chunk 20-4.

The transition section in the action section of the action P is a section in which the transition from the action P to another action is performed. Specifically, the transition section is indicated by a non-belonging chunk at the tail of the action section. For example, in FIG. 11, the transition section of the action section A1 is a chunk 20-6.

The detection unit 2020 computes, as the action time, the length of the actual action section (hereinafter referred to as an actual action time), the length of the interruption section (hereinafter referred to as an interruption time), and the length of the transition section (hereinafter referred to as a transition time). Note that, the detection unit 2020 may compute only a part of such times. That is, the detection unit 2020 may compute only one of, or only two of, the actual action time, the interruption time, and the transition time.

For example, in the example of FIG. 11, the actual action time of the action section A1 is the sum of the length of the chunk 20-1, the length of the chunk 20-3, and the length of the chunk 20-5. The interruption time of the action section A1 is the sum of the length of the chunk 20-2 and the length of the chunk 20-4. Further, the transition time of the action period A1 is the length of the chunk 20-6.

Here, the length of time may be expressed in various ways (units). For example, the length of time is expressed in milliseconds, seconds, minutes, or the like. In another example, the length of time may be expressed by the number of frames. That is, the length of the action time is expresses by the number of frames constituting the chunk 20. For example, in the example of FIG. 11, the actual action time of the action section A1 may be expressed by the sum of the number of video frames 12 constituting the chunk 20-1, the number of video frames 12 constituting the chunk 20-3, and the number of video frames 12 constituting the chunk 20-5.

Note that, the transition section may be treated as one of the interruption sections, without distinguishing between the transition section and the interruption section. In such a case, the interruption section in the action section of the action P is indicated by all the non-belonging chunks in the action section.

### <Abnormality Analysis: S108>

The analysis unit 2060 performs abnormal analysis of the action in the second video frame sequence 30, based on the order of the actions in the second video frame sequence 30 and the action time of each action (S108).

For this purpose, for example, the analysis unit 2060 computes a degree of deviation (in other words, a degree of dissimilarity) between the order of the actions indicated by the second video frame sequence 30 and the order of the actions defined for the cycles indicated by the second video frame sequence 30. Thus, the order of the actions in the second video frame sequence 30 is used for the abnormal analysis of the actions in the second video frame sequence 30.

The order of the actions indicated by the second video frame sequence 30 is indicated by a class sequence acquired from the second video frame sequence 30. For example, in the example of FIG. 11, a class sequence acquired from the second video frame sequence 30 is (C1, C2, C3). Further, the order of the actions defined for the cycle indicated by the second video frame sequence 30 is indicated by the definition sequence of the cycle.

Here, the class sequence acquired from the second video frame sequence 30 may include a non-belonging chunk. In such a case, in the example of FIG. 11, a class sequence acquired from the second video frame sequence 30 is (C1, N, C1, N, C1, N, C2, N, C2, C3, N, C3).

The analysis unit 2060 converts the second video frame sequence 30 into a class sequence, and computes a magnitude of the difference between the class sequence and the definition sequence of the cycle indicated by the second video frame sequence 30. The degree of deviation (hereinafter, deviation degree) between the two class sequences can be indicated by, for example, an edit distance. Thus, for example, the analysis unit 2060 computes the edit distance between the class sequence acquired from the second video frame sequence 30 and the definition sequence of the cycle indicated by the second video frame sequence 30.

As described above, the cycle definition information 400 may indicate a plurality of definition sequences for a single cycle. When there is a plurality of definition sequences of a cycle indicated by the second video frame sequence 30, the analysis unit 2060 computes the deviation degree between the class sequence acquired from the second video frame sequence 30 and each of the plurality of definition sequences. Then, the analysis unit 2060 utilizes a statistical value (for example, the minimum value, the maximum value, an average value, or the like) of the plurality of the computed deviation degrees as the deviation degree between the class sequence acquired from the second video frame sequence 30 and the definition sequence of the cycle indicated by the second video frame sequence 30.

### <<Computation of Abnormality>>

For example, the analysis unit 2060 computes the abnormality degree of the second video frame sequence 30 by using the deviation degree from the definition sequence and the action time. For example, the analysis unit 2060 computes the abnormality degree of the second video frame sequence 30 by utilizing a machine learning-based model. Hereinafter, this model is referred to as an “abnormality degree computation model”. The abnormality degree computation model is achieved by a neural network, a regression model, or the like.

For example, the abnormality degree computation model is configured to acquire a feature vector indicating a feature of the second video frame sequence 30 as an input, and output an abnormality degree of an action indicated by the second video frame sequence 30 in response to the feature vector being input. The feature vector is, for example, a vector in which the deviation degree from the definition sequence and information regarding each action section are enumerated.

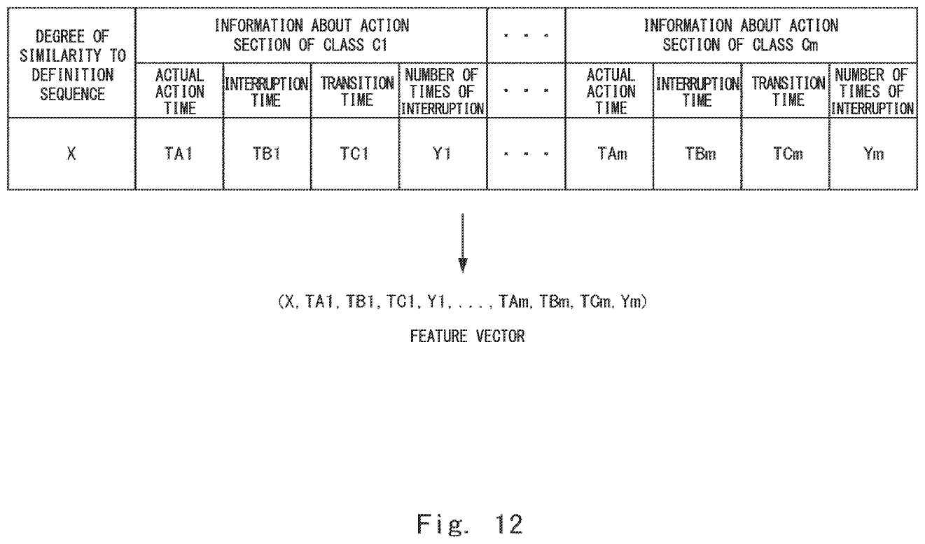

FIG. 12 is a diagram illustrating an example of a feature vector of the second video frame sequence 30. The feature vector includes information about a similarity to the definition sequence and information about an action section of each class.

In this example, m classes from class C1 to Cm are treated by the abnormality analysis apparatus 2000. Therefore, the feature vector in FIG. 12 indicates information about an action section for each of the classes C1 to Cm. The information about the action section indicates an actual action time, an interruption time, a transition time, and the number of interruptions. The number of interruptions indicates the number of interruption sections included in the action section.

Here, there may be a plurality of action sections of the same class in the second video frame sequence 30. In a case where there is a plurality of action sections of the same class, the analysis unit 2060 utilizes, in the feature vector, statistical values of the values computed for the plurality of sections in the information about the action section of the class.

For example, in the second video frame sequence 30, it is assumed that each of the action sections A5 and A10 is an action section of the class C7. In such a case, in the feature vector, information about the class C7 is determined by a statistical value of the values acquired for the action section A5 and values acquired for the action section A10. As a more specific example, statistical values of an actual action time of the action section A5 and an actual action time of the action section A10 are used as the actual action time of the class C7.

In the feature vector, for example, as information about a class not included in the second video frame sequence 30, a standard value for such class is being used. The standard value for a class is, for example, a statistical value computed from a history of past video frame sequences for an action section of such class. Here, it is preferable that the standard value is determined by using only a video frame sequence indicating a normal action among histories of past video frame sequences. In other words, it is preferable that a past video frame sequence indicating an abnormal action is not used for the computation of the standard value.

The abnormality degree computation model is trained in advance by using training data. The training data associates input data with output data (hereinafter, ground truth data) to be output from the abnormality degree computation model when the input data is input to the abnormality degree computation model. More specifically, the training data associates the feature vector with an abnormality degree of the video frame sequence having the feature indicated by the feature vector. An apparatus (hereinafter, referred to as a training apparatus) that is configured to train a model trains the abnormality degree computation model by updating trainable parameters of the abnormality degree computation model by using such training data.

In another example, the analysis unit 2060 may compute the abnormality degree of the second video frame sequence 30 by using an auto encoder. In such a case, the autoencoder is configured to encode a feature vector of the second video frame sequence 30 and decode the encoded result, in response to an input of the feature vector, and output a vector indicating the decoded result.

The analysis unit 2060 uses the magnitude of the reconstruction error by the auto encoder as an abnormality degree of the second video frame sequence 30. That is, the analysis unit 2060 uses the deviation degree (for example, the distance between two vectors) between the feature vector of the second video frame sequence 30 and the vector output from the auto encoder as the degree of abnormality of the action indicated by the second video frame sequence 30.

The autoencoder is trained in advance by using training data. The training data is, for example, a video data sequence indicating a normal action. The autoencoder is trained to output, when a video data sequence indicating a normal action is input thereto, data that is sufficiently similar to the input data.

The method for computing the abnormality degree is not limited to a method using the machine learning-based model. For example, the analysis unit 2060 may compute the abnormality degree of the action indicated by the second video frame sequence 30 by the following method.

For example, for the second video frame sequence 30, the analysis unit 2060 computes an abnormality degree for each of a plurality of indices by using feature vectors acquired from each of a plurality of past video frame sequences (in other words, the history of the video frame sequence). In the example of FIG. 12, the indices are the deviation degree from the definition sequence, the actual action time, the interruption time, the transition time, and the number of interruptions.

Specifically, the analysis unit 2060 computes a standard value and a variation for each index and for each class by using a plurality of feature vectors acquired from the history of the video frame sequence. A standard value of an index is indicated by, for example, an average value or a median value of a plurality of values in the past. A variation of the index is indicated by, for example, a standard deviation of a plurality of values in the past. Here, the past video frame sequence being used is preferably a video frame sequence indicating a normal action.

The past video frame sequence is stored in advance in the storage unit in such a manner that the past video frame sequence can be acquired from the abnormality analysis apparatus 2000. However, the storage unit may store the feature vector acquired from the past video frame sequence in addition to or instead of the past video frame sequence.

The analysis unit 2060 computes the abnormality degree of each index for the second video frame sequence 30 by using the computed standard value (for example, average value) and variation of each index and the feature vector acquired from the second video frame sequence 30. The abnormality degree of each index is computed, for example, by using the following equation (1).

$$Equation 1$$

$$\begin{matrix}q [ a ] [ b ] = \{ \begin{matrix}0 , & if ( T [ a ] [ b ] - μ [ a ] [ b ] ) < k σ [ a ] [ b ] \\ \frac{T [ a ] [ b ] - μ [ a ] [ b ]}{k σ [ a ] [ b ]} , & else\end{matrix} \\ Q [ a ] = {\sum }_{1 \leq b \leq m} q [ a ] [ b ]\end{matrix} \qquad ( 1 )$$

a indicates identification information of an index. b indicates identification information of a class. q[a][b] indicates an abnormality degree of the index a computed for the class b. For example, when a indicates an actual action time and b indicates a class C1, q[a][b] indicates an abnormality degree of the actual action time in the action of the class C1 for the second video frame sequence 30. Q[a][b] indicates an abnormality degree of the index a computed for the second video frame sequence 30.

T[a][b] indicates the value of the index a in the action section of the class b computed for the second video frame sequence 30. μ[a][b] indicates an average value of values of the past index a computed for class b by using the history. σ[a][b] indicates a standard deviation of the value of the past index a computed for class b by using the history. k is a predetermined positive real number.

By computing the abnormality degree for each index, the abnormality degree of the action in the second video frame sequence 30 can be grasped from various viewpoints. According to the degree of abnormality based on the deviation degree from the definition sequence, it is possible to comprehensively grasp the degree of difference in the order of the actions from the original order, the amount of lacks of the actions, the amount of extra actions, and the like. For example, when the order of the actions in the second video frame sequence 30 is significantly different from the original order, there are many lacks in the actions, or there are many extra actions, the degree of abnormality based on the deviation degree from the definition sequence increases.

According to the abnormality degree based on the actual action time, it is possible to grasp the degree of deviation of the length of the actual action time in the second video frame sequence 30 from the length of a standard actual action time. According to the abnormality degree based on the interruption time, it is possible to grasp the degree of deviation of the length of the interruption time in the second video frame sequence 30 from the length of a standard interruption time. According to the abnormality degree based on the transition time, it is possible to grasp the degree of deviation of the length of the transition time in the second video frame sequence 30 from the length of a standard transition time. According to the abnormality degree based on the number of interruptions, it is possible to grasp the degree of deviation of the number of interruptions in the second video frame sequence 30 from the standard number of interruptions.

The analysis unit 2060 may compute the abnormality degree of the action indicated by the second video frame sequence 30 by using an abnormality degree Q[a] computed for each index a. For example, the abnormality degree of the action indicated by the second video frame sequence 30 may be indicated by the sum of Q[a]s computed for each index, a simple average, a weighted average, or other statistical values.

As described above, according to the method for computing an abnormality degree of an action time by comparing the statistical value of the action time acquired from the past video frame sequence with the action time acquired from the chunk 20, the abnormality degree of the action indicated by the second video frame sequence 30 can be grasped by using past data as a reference.

### <<Abnormality Determination>>

The analysis unit 2060 may determine whether the actions indicated by the second video frame sequence 30 are abnormal. For example, the analysis unit 2060 determines whether the actions indicated by the second video frame sequence 30 are abnormal by using the abnormality degree computed for the second video frame sequence 30.

For example, when the abnormality degree computed for the second video frame sequence 30 is equal to or greater than a threshold value, the analysis unit 2060 determines that the actions indicated by the second video frame sequence 30 are abnormal. Meanwhile, when the abnormality degree computed for the second video frame sequence 30 is less than the threshold value, the analysis unit 2060 determines that the actions indicated by the second video frame sequence 30 is not abnormal.

Here, as described above, the analysis unit 2060 may compute the abnormality degree for each of the plurality of indices for the second video frame sequence 30. For example, an abnormality degree based on the deviation degree from the definition sequence, an abnormality degree based on the actual action time, an abnormality degree based on the interruption time, and the like. In such a case, the analysis unit 2060 may perform abnormality determination by using the abnormality degree computed for each of the plurality of indices.

There are various methods for determining abnormality using abnormality degrees for each of a plurality of indices. For example, the analysis unit 2060 determines that the actions indicated by the second video frame sequence 30 are not abnormal when the abnormality degrees of the plurality of indices are all less than a threshold value. Meanwhile, when the abnormality degree of at least one index is equal to or greater than the threshold value, the analysis unit 2060 determines that the actions indicated by the second video frame sequence 30 are abnormal. The threshold value may be set for each index, or may be a common value for all indices.

As an example, it is assumed that the abnormality degree based on the deviation degree from the definition sequence, the abnormality degree based on the actual action time, and the abnormality degree based on the interruption time are to be used. When all of these three types of abnormality degrees are less than the threshold value, the analysis unit 2060 determines that the actions indicated by the second video frame sequence 30 is not abnormal. Meanwhile, when at least one of these three types of abnormality degrees is equal to or greater than the threshold value, the analysis unit 2060 determines that the actions indicated by the second video frame sequence 30 are abnormal.

In another example, the analysis unit 2060 may determine that the actions indicated by the second video frame sequence 30 are abnormal when the abnormality degree of each of a predetermined number or more of indices is equal to or greater than the threshold value. For example, in a case where the abnormality degree is being computed for each of the three indices as described above, when the abnormality degree of each of two or more indices is equal to or greater than the threshold value, it is determined that the actions indicated by the second video frame sequence 30 are abnormal. In such a case, when only one of the abnormality degrees based on each of the three types of indices is equal to or greater than the threshold value, or when all of the abnormality degrees is less than the threshold value, it is determined that the actions indicated by the second video frame sequence 30 is not abnormal.

The analysis unit 2060 may determine whether the actions indicated by the second video frame sequence 30 are abnormal, without explicitly acquiring the abnormality degree for the second video frame sequence 30. In such a case, for example, the analysis unit 2060 includes a model configured to output a determination result as to whether the actions indicated by the second video frame sequence 30 are abnormal, in response to the feature vector of the second video frame sequence 30 being input thereinto. Hereinafter, such a model is referred to as a “determination model”.

The decision model is achieved by, for example, a neural network or a support vector machine (SVM). Similarly to the abnormality degree computation model, the determination model is also trained in advance by using training data indicating a combination of input data and ground truth data.

### <Output of Results>

The abnormality analysis apparatus 2000 outputs the execution result. Hereinafter, information output from the abnormality analysis apparatus 2000 is referred to as “output information”. The output information indicates an analysis result of the abnormality indicated by the second video frame sequence 30. For example, the output information indicates the abnormality degree of the action indicated by the second video frame sequence 30, the abnormality degree computed for each index, or the determination result of whether the actions indicated by the second video frame sequence 30 are abnormal.

The output mode of the output information may be any mode. For example, the abnormality analysis apparatus 2000 puts the output information into any storage device. In another example, the abnormality analysis apparatus 2000 may transmit the output information to any device. In another example, the abnormality analysis apparatus 2000 may display the content of the output information on a display device.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The program includes instructions (or software codes) that, when loaded into a computer, cause the computer to perform one or more of the functions described in the embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

According to the present disclosure, a novel technique for analyzing an abnormality of an action is provided.

Some or all of the above-described example embodiments may be described as the following supplementary notes, but are not limited thereto.

### (Supplementary Note 1)

An abnormality analysis apparatus comprising:
at least one memory that is configured to store instructions; and
at least one processor that is configured to execute the instructions to:
detect, from a first video frame sequence, a second video frame sequence indicating a cycle being a set of a predetermined plurality of actions;
determine an action time for each one of the actions indicated by the second video frame sequence; and
analyze an abnormality of the actions indicated by the second video frame sequence, based on an order of the actions indicated by the second video frame sequence and the action time of each one of the actions.

### (Supplementary Note 2)

The abnormality analysis apparatus according to supplementary note 1, wherein the analysis of the abnormality of the actions includes performing, based on a degree of deviation between the order of the actions indicated by the second video frame sequence and an order of the actions according to a definition of the cycle:
computing a degree of the abnormality of the actions indicated by the second video frame sequence; or
determining whether or not the actions indicated by the second video frame sequence are abnormal.

### (Supplementary Note 3)

The abnormality analysis apparatus according to supplementary note 2, wherein
the at least one memory further stores a model that is trained to output a degree of abnormality of actions indicated by a video frame sequence in response to input data being input thereinto, the input data including: a degree of deviation between an order of the actions indicated by that video frame sequence and the order of the actions according to the definition of the cycle; and an action time of each one of the actions indicated by that video frame sequence, and
the analysis of the abnormality of the actions includes inputting, into the model, the degree of deviation between the order of the actions indicated by the second video frame sequence and the order of the actions according to the definition of the cycle and the action time determined for each one the actions indicated by the second video frame sequence, thereby computing the degree of the abnormality of the actions indicated by the second video frame sequence.

### (Supplementary Note 4)

The abnormality analysis apparatus according to supplementary note 2, wherein
the analysis of the abnormality of the actions includes:
computing a statistical value of the action times for each one of the actions based on a plurality of past video frame sequences; and
computing a degree of abnormality of the action time, based on the statistical value of the action times computed for each one of the actions and the action time determined for each one of the actions indicated by the second video frame sequence.

### (Supplementary Note 5)

The abnormality analysis apparatus according to supplementary note 3, wherein
the determination of the action time includes computing an actual action time and an interruption time for each one of the actions indicated by the second video frame sequence, the actual action time being a length of time during which the action is performed, the interruption time being a length of time during which the action is interrupted, and
the analysis of the abnormality of the actions includes:
computing a statistical value of the actual action times and a statistical value of the interruption times for each one of the actions, based on a plurality of past video frame sequences; and
computing a degree of abnormality of the actual action time and a degree of abnormality of the interruption time with respect to the second video frame sequence, based on the computed statistical value of the actual action times and the computed statistical value of the interruption times, and the actual action time and the interruption time determined for each one of the actions indicated by the second video frame sequence.

### (Supplementary Note 6)

The abnormality analysis apparatus according to supplementary note 1, wherein the detection of the second video frame sequence includes:
acquiring cycle definition information including, at least, one or more actions at a head of the cycle and one or more actions at a tail of the cycle;
generating a permutation of the actions indicated by the first video frame by detecting a plurality of sets of consecutive video frames from the first vide frame, the consecutive video frames in the set indicating a same action as each other; and
detecting a position of the head of the cycle and a position of the tail of the cycle from the generated permutation of the actions by using the cycle definition information, and thereby detecting a position of the head of the cycle and a position of the tail of the cycle from the first video frame sequence.

### (Supplementary Note 7)

The abnormality analysis apparatus according to supplementary note 6, wherein
the cycle definition information includes a permutation of actions indicating a head of the cycle, and
the detection of the second video frame sequence includes detecting the position of the head of the cycle by detecting, in an order indicated in the cycle definition information, a plurality of actions included in the permutation of the actions indicating the head of the cycle from the permutation of the actions indicated by the first video frame.

### (Supplementary Note 8)

The abnormality analysis apparatus according to supplementary note 6, wherein
the cycle definition information includes a plurality of actions indicating a tail of the cycle, and
the detection of the second video frame sequence includes detecting the position of the tail of the cycle by detecting a predetermined number or more of actions indicating the tail of the cycle from a portion of the permutation of the actions indicated by the first video frame that is after the position of the head of the cycle, and by detecting an action other than an action indicating the tail of the cycle from a portion after where the predetermined number of actions are detected.

### (Supplementary Note 9)

An abnormality analysis method executed by a computer, comprising:
detecting, from a first video frame sequence, a second video frame sequence indicating a cycle being a set of a predetermined plurality of actions;
determining an action time for each one of the actions indicated by the second video frame sequence; and
analyzing an abnormality of the actions indicated by the second video frame sequence, based on an order of the actions indicated by the second video frame sequence and the action time of each one of the actions.

### (Supplementary Note 10)

The abnormality analysis method according to supplementary note 9, wherein the analysis of the abnormality of the actions includes performing, based on a degree of deviation between the order of the actions indicated by the second video frame sequence and an order of the actions according to a definition of the cycle:
computing a degree of the abnormality of the actions indicated by the second video frame sequence; or
determining whether or not the actions indicated by the second video frame sequence are abnormal.

### (Supplementary Note 11)

The abnormality analysis method according to supplementary note 10, wherein
the computer stores a model that is trained to output a degree of abnormality of actions indicated by a video frame sequence in response to input data being input thereinto, the input data including: a degree of deviation between an order of the actions indicated by that video frame sequence and the order of the actions according to the definition of the cycle; and an action time of each one of the actions indicated by that video frame sequence, and
the analysis of the abnormality of the actions includes inputting, into the model, the degree of deviation between the order of the actions indicated by the second video frame sequence and the order of the actions according to the definition of the cycle and the action time determined for each one the actions indicated by the second video frame sequence, thereby computing the degree of the abnormality of the actions indicated by the second video frame sequence.

### (Supplementary Note 12)

The abnormality analysis method according to supplementary note 10, wherein
the analysis of the abnormality of the actions includes:
computing a statistical value of the action times for each one of the actions based on a plurality of past video frame sequences; and
computing a degree of abnormality of the action time, based on the statistical value of the action times computed for each one of the actions and the action time determined for each one of the actions indicated by the second video frame sequence.

### (Supplementary Note 13)

The abnormality analysis method according to supplementary note 11, wherein
the determination of the action time includes computing an actual action time and an interruption time for each one of the actions indicated by the second video frame sequence, the actual action time being a length of time during which the action is performed, the interruption time being a length of time during which the action is interrupted, and
the analysis of the abnormality of the actions includes:
computing a statistical value of the actual action times and a statistical value of the interruption times for each one of the actions, based on a plurality of past video frame sequences; and
computing a degree of abnormality of the actual action time and a degree of abnormality of the interruption time with respect to the second video frame sequence, based on the computed statistical value of the actual action times and the computed statistical value of the interruption times, and the actual action time and the interruption time determined for each one of the actions indicated by the second video frame sequence.

### (Supplementary Note 14)

The abnormality analysis method according to supplementary note 9, wherein the detection of the second video frame sequence includes:
acquiring cycle definition information including, at least, one or more actions at a head of the cycle and one or more actions at a tail of the cycle;
generating a permutation of the actions indicated by the first video frame by detecting a plurality of sets of consecutive video frames from the first vide frame, the consecutive video frames in the set indicating a same action as each other; and
detecting a position of the head of the cycle and a position of the tail of the cycle from the generated permutation of the actions by using the cycle definition information, and thereby detecting a position of the head of the cycle and a position of the tail of the cycle from the first video frame sequence.

### (Supplementary Note 15)

The abnormality analysis method according to supplementary note 14, wherein
the cycle definition information includes a permutation of actions indicating a head of the cycle, and
the detection of the second video frame sequence includes detecting the position of the head of the cycle by detecting, in an order indicated in the cycle definition information, a plurality of actions included in the permutation of the actions indicating the head of the cycle from the permutation of the actions indicated by the first video frame.

### (Supplementary Note 16)

The abnormality analysis method according to supplementary note 14, wherein
the cycle definition information includes a plurality of actions indicating a tail of the cycle, and
the detection of the second video frame sequence includes detecting the position of the tail of the cycle by detecting a predetermined number or more of actions indicating the tail of the cycle from a portion of the permutation of the actions indicated by the first video frame that is after the position of the head of the cycle, and by detecting an action other than an action indicating the tail of the cycle from a portion after where the predetermined number of actions are detected.

### (Supplementary Note 17)

A non-transitory computer-readable medium storing a program causing a computer to execute:
detecting, from a first video frame sequence, a second video frame sequence indicating a cycle being a set of a predetermined plurality of actions;
determining an action time for each one of the actions indicated by the second video frame sequence; and
analyzing an abnormality of the actions indicated by the second video frame sequence, based on an order of the actions indicated by the second video frame sequence and the action time of each one of the actions.

### (Supplementary Note 18)

The program according to supplementary note 17, wherein the analysis of the abnormality of the actions includes performing, based on a degree of deviation between the order of the actions indicated by the second video frame sequence and an order of the actions according to a definition of the cycle:
computing a degree of the abnormality of the actions indicated by the second video frame sequence; or
determining whether or not the actions indicated by the second video frame sequence are abnormal.

### (Supplementary Note 19)

The program according to supplementary note 18, wherein
the program includes a model that is trained to output a degree of abnormality of actions indicated by a video frame sequence in response to input data being input thereinto, the input data including: a degree of deviation between an order of the actions indicated by that video frame sequence and the order of the actions according to the definition of the cycle; and an action time of each one of the actions indicated by that video frame sequence, and
the analysis of the abnormality of the actions includes inputting, into the model, the degree of deviation between the order of the actions indicated by the second video frame sequence and the order of the actions according to the definition of the cycle and the action time determined for each one the actions indicated by the second video frame sequence, thereby computing the degree of the abnormality of the actions indicated by the second video frame sequence.

### (Supplementary Note 20)

The program according to supplementary note 18, wherein the analysis of the abnormality of the actions includes:
computing a statistical value of the action times for each one of the actions based on a plurality of past video frame sequences; and
computing a degree of abnormality of the action time, based on the statistical value of the action times computed for each one of the actions and the action time determined for each one of the actions indicated by the second video frame sequence.

### (Supplementary Note 21)

The program according to supplementary note 19, wherein
the determination of the action time includes computing an actual action time and an interruption time for each one of the actions indicated by the second video frame sequence, the actual action time being a length of time during which the action is performed, the interruption time being a length of time during which the action is interrupted, and
the analysis of the abnormality of the actions includes:
computing a statistical value of the actual action times and a statistical value of the interruption times for each one of the actions, based on a plurality of past video frame sequences; and
computing a degree of abnormality of the actual action time and a degree of abnormality of the interruption time with respect to the second video frame sequence, based on the computed statistical value of the actual action times and the computed statistical value of the interruption times, and the actual action time and the interruption time determined for each one of the actions indicated by the second video frame sequence.

### (Supplementary Note 22)

The program according to any one of supplementary notes 17 to 21, wherein the detection of the second video frame sequence includes:
acquiring cycle definition information including, at least, one or more actions at a head of the cycle and one or more actions at a tail of the cycle;
generating a permutation of the actions indicated by the first video frame by detecting a plurality of sets of consecutive video frames from the first vide frame, the consecutive video frames in the set indicating a same action as each other; and
detecting a position of the head of the cycle and a position of the tail of the cycle from the generated permutation of the actions by using the cycle definition information, and thereby detecting a position of the head of the cycle and a position of the tail of the cycle from the first video frame sequence.

### (Supplementary Note 23)

The program according to supplementary note 22, wherein
the cycle definition information includes a permutation of actions indicating a head of the cycle, and
the detection of the second video frame sequence includes detecting the position of the head of the cycle by detecting, in an order indicated in the cycle definition information, a plurality of actions included in the permutation of the actions indicating the head of the cycle from the permutation of the actions indicated by the first video frame.

### (Supplementary Note 24)

The program according to supplementary note 22, wherein
the cycle definition information includes a plurality of actions indicating a tail of the cycle, and
the detection of the second video frame sequence includes detecting the position of the tail of the cycle by detecting a predetermined number or more of actions indicating the tail of the cycle from a portion of the permutation of the actions indicated by the first video frame that is after the position of the head of the cycle, and by detecting an action other than an action indicating the tail of the cycle from a portion after where the predetermined number of actions are detected.

What is claimed is:

1. An abnormality analysis apparatus comprising:
at least one memory that is configured to store instructions; and
at least one processor that is configured to execute the instructions to:
detect, from a first video frame sequence, a second video frame sequence indicating a cycle being a set of a predetermined plurality of actions;
determine an action time for each one of the actions indicated by the second video frame sequence; and
analyze an abnormality of the actions indicated by the second video frame sequence, based on an order of the actions indicated by the second video frame sequence and the action time of each one of the actions.

2. The abnormality analysis apparatus according to claim 1, wherein the analysis of the abnormality of the actions includes performing, based on a degree of deviation between the order of the actions indicated by the second video frame sequence and an order of the actions according to a definition of the cycle:
computing a degree of the abnormality of the actions indicated by the second video frame sequence; or
determining whether or not the actions indicated by the second video frame sequence are abnormal.

3. The abnormality analysis apparatus according to claim 2, wherein
the at least one memory further stores a model that is trained to output a degree of abnormality of actions indicated by a video frame sequence in response to input data being input thereinto, the input data including: a degree of deviation between an order of the actions indicated by that video frame sequence and the order of the actions according to the definition of the cycle; and an action time of each one of the actions indicated by that video frame sequence, and
the analysis of the abnormality of the actions includes inputting, into the model, the degree of deviation between the order of the actions indicated by the second video frame sequence and the order of the actions according to the definition of the cycle and the action time determined for each one the actions indicated by the second video frame sequence, thereby computing the degree of the abnormality of the actions indicated by the second video frame sequence.

4. The abnormality analysis apparatus according to claim 2, wherein
the analysis of the abnormality of the actions includes:
computing a statistical value of the action times for each one of the actions based on a plurality of past video frame sequences; and
computing a degree of abnormality of the action time, based on the statistical value of the action times computed for each one of the actions and the action time determined for each one of the actions indicated by the second video frame sequence.

5. The abnormality analysis apparatus according to claim 3, wherein
the determination of the action time includes computing an actual action time and an interruption time for each one of the actions indicated by the second video frame sequence, the actual action time being a length of time during which the action is performed, the interruption time being a length of time during which the action is interrupted, and
the analysis of the abnormality of the actions includes:
computing a statistical value of the actual action times and a statistical value of the interruption times for each one of the actions, based on a plurality of past video frame sequences; and
computing a degree of abnormality of the actual action time and a degree of abnormality of the interruption time with respect to the second video frame sequence, based on the computed statistical value of the actual action times and the computed statistical value of the interruption times, and the actual action time and the interruption time determined for each one of the actions indicated by the second video frame sequence.

6. The abnormality analysis apparatus according to claim 1, wherein the detection of the second video frame sequence includes:
acquiring cycle definition information including, at least, one or more actions at a head of the cycle and one or more actions at a tail of the cycle;
generating a permutation of the actions indicated by the first video frame by detecting a plurality of sets of consecutive video frames from the first vide frame, the consecutive video frames in the set indicating a same action as each other; and
detecting a position of the head of the cycle and a position of the tail of the cycle from the generated permutation of the actions by using the cycle definition information, and thereby detecting a position of the head of the cycle and a position of the tail of the cycle from the first video frame sequence.

7. The abnormality analysis apparatus according to claim 6, wherein
the cycle definition information includes a permutation of actions indicating a head of the cycle, and
the detection of the second video frame sequence includes detecting the position of the head of the cycle by detecting, in an order indicated in the cycle definition information, a plurality of actions included in the permutation of the actions indicating the head of the cycle from the permutation of the actions indicated by the first video frame.

8. The abnormality analysis apparatus according to claim 6, wherein
the cycle definition information includes a plurality of actions indicating a tail of the cycle, and
the detection of the second video frame sequence includes detecting the position of the tail of the cycle by detecting a predetermined number or more of actions indicating the tail of the cycle from a portion of the permutation of the actions indicated by the first video frame that is after the position of the head of the cycle, and by detecting an action other than an action indicating the tail of the cycle from a portion after where the predetermined number of actions are detected.

9. An abnormality analysis method executed by a computer, comprising:
detecting, from a first video frame sequence, a second video frame sequence indicating a cycle being a set of a predetermined plurality of actions;
determining an action time for each one of the actions indicated by the second video frame sequence; and
analyzing an abnormality of the actions indicated by the second video frame sequence, based on an order of the actions indicated by the second video frame sequence and the action time of each one of the actions.

10. The abnormality analysis method according to claim 9, wherein the analysis of the abnormality of the actions includes performing, based on a degree of deviation between the order of the actions indicated by the second video frame sequence and an order of the actions according to a definition of the cycle:
computing a degree of the abnormality of the actions indicated by the second video frame sequence; or
determining whether or not the actions indicated by the second video frame sequence are abnormal.

11. The abnormality analysis method according to claim 10, wherein
the computer stores a model that is trained to output a degree of abnormality of actions indicated by a video frame sequence in response to input data being input thereinto, the input data including: a degree of deviation between an order of the actions indicated by that video frame sequence and the order of the actions according to the definition of the cycle; and an action time of each one of the actions indicated by that video frame sequence, and
the analysis of the abnormality of the actions includes inputting, into the model, the degree of deviation between the order of the actions indicated by the second video frame sequence and the order of the actions according to the definition of the cycle and the action time determined for each one the actions indicated by the second video frame sequence, thereby computing the degree of the abnormality of the actions indicated by the second video frame sequence.

12. The abnormality analysis method according to claim 10, wherein
the analysis of the abnormality of the actions includes:
computing a statistical value of the action times for each one of the actions based on a plurality of past video frame sequences; and
computing a degree of abnormality of the action time, based on the statistical value of the action times computed for each one of the actions and the action time determined for each one of the actions indicated by the second video frame sequence.

13. The abnormality analysis method according to claim 11, wherein
the determination of the action time includes computing an actual action time and an interruption time for each one of the actions indicated by the second video frame sequence, the actual action time being a length of time during which the action is performed, the interruption time being a length of time during which the action is interrupted, and
the analysis of the abnormality of the actions includes:
computing a statistical value of the actual action times and a statistical value of the interruption times for each one of the actions, based on a plurality of past video frame sequences; and
computing a degree of abnormality of the actual action time and a degree of abnormality of the interruption time with respect to the second video frame sequence, based on the computed statistical value of the actual action times and the computed statistical value of the interruption times, and the actual action time and the interruption time determined for each one of the actions indicated by the second video frame sequence.

14. The abnormality analysis method according to claim 9, wherein the detection of the second video frame sequence includes:
acquiring cycle definition information including, at least, one or more actions at a head of the cycle and one or more actions at a tail of the cycle;
generating a permutation of the actions indicated by the first video frame by detecting a plurality of sets of consecutive video frames from the first vide frame, the consecutive video frames in the set indicating a same action as each other; and
detecting a position of the head of the cycle and a position of the tail of the cycle from the generated permutation of the actions by using the cycle definition information, and thereby detecting a position of the head of the cycle and a position of the tail of the cycle from the first video frame sequence.

15. A non-transitory computer-readable medium storing a program causing a computer to execute:
detecting, from a first video frame sequence, a second video frame sequence indicating a cycle being a set of a predetermined plurality of actions;
determining an action time for each one of the actions indicated by the second video frame sequence; and
analyzing an abnormality of the actions indicated by the second video frame sequence, based on an order of the actions indicated by the second video frame sequence and the action time of each one of the actions.

16. The non-transitory computer-readable medium according to claim 15, wherein the analysis of the abnormality of the actions includes performing, based on a degree of deviation between the order of the actions indicated by the second video frame sequence and an order of the actions according to a definition of the cycle:
computing a degree of the abnormality of the actions indicated by the second video frame sequence; or
determining whether or not the actions indicated by the second video frame sequence are abnormal.

17. The non-transitory computer-readable medium according to claim 16, wherein
the program includes a model that is trained to output a degree of abnormality of actions indicated by a video frame sequence in response to input data being input thereinto, the input data including: a degree of deviation between an order of the actions indicated by that video frame sequence and the order of the actions according to the definition of the cycle; and an action time of each one of the actions indicated by that video frame sequence, and
the analysis of the abnormality of the actions includes inputting, into the model, the degree of deviation between the order of the actions indicated by the second video frame sequence and the order of the actions according to the definition of the cycle and the action time determined for each one the actions indicated by the second video frame sequence, thereby computing the degree of the abnormality of the actions indicated by the second video frame sequence.

18. The non-transitory computer-readable medium according to claim 16, wherein the analysis of the abnormality of the actions includes:
computing a statistical value of the action times for each one of the actions based on a plurality of past video frame sequences; and
computing a degree of abnormality of the action time, based on the statistical value of the action times computed for each one of the actions and the action time determined for each one of the actions indicated by the second video frame sequence.

19. The non-transitory computer-readable medium according to claim 17, wherein
the determination of the action time includes computing an actual action time and an interruption time for each one of the actions indicated by the second video frame sequence, the actual action time being a length of time during which the action is performed, the interruption time being a length of time during which the action is interrupted, and
the analysis of the abnormality of the actions includes:
computing a statistical value of the actual action times and a statistical value of the interruption times for each one of the actions, based on a plurality of past video frame sequences; and
computing a degree of abnormality of the actual action time and a degree of abnormality of the interruption time with respect to the second video frame sequence, based on the computed statistical value of the actual action times and the computed statistical value of the interruption times, and the actual action time and the interruption time determined for each one of the actions indicated by the second video frame sequence.

20. The non-transitory computer-readable medium according to claim 15, wherein the detection of the second video frame sequence includes:
acquiring cycle definition information including, at least, one or more actions at a head of the cycle and one or more actions at a tail of the cycle;
generating a permutation of the actions indicated by the first video frame by detecting a plurality of sets of consecutive video frames from the first vide frame, the consecutive video frames in the set indicating a same action as each other; and
detecting a position of the head of the cycle and a position of the tail of the cycle from the generated permutation of the actions by using the cycle definition information, and thereby detecting a position of the head of the cycle and a position of the tail of the cycle from the first video frame sequence.
